(19) United States
(12) Patent Application Publication
(10) Pub. No.: US 2026/0141559 A1
(43) Pub. Date: May 21, 2026

(54) Electrode Transport System and Control Method Thereof

(71) Applicant: SK On Co., Ltd., Seoul (KR)

(72) Inventors: Soo Yeon PARK, Daejeon (KR); Dong Hyun SEO, Daejeon (KR); Ji Won YANG, Daejeon (KR); Jeong Seob LEE, Daejeon (KR)

(21) Appl. No.: 19/393,743

(22) Filed: Nov. 19, 2025

(30) Foreign Application Priority Data
Nov. 21, 2024 (KR) 10-2024-0167324
Dec. 26, 2024 (KR) 10-2024-0197003

(51) Int. Cl. G06T 7/73

(52) U.S. Cl. CPC G06T 7/74; G06T 2207/30108

(57) ABSTRACT

The present disclosure relates to an electrode transport system. The electrode transport system may comprise: a first transport device for transporting the electrode; a first plate onto which the electrode transported from the first transport device is placed; a camera positioned spaced apart from the side of the first plate opposite the side where the electrode is placed and shooting the electrode placed on the first plate; and a support part included within the shooting region of the camera and forming a portion of the first plate, wherein the support part may be formed of a material to transmit at least a portion of light within a wavelength range detectable by the camera.

### CROSS-REFERENCE TO RELATED PATENT APPLICATION

The present application claims priority under 35 U.S.C. § 119a to Korean patent applications number 10-2024-0167324 filed on November 21, 2024 and 10-2024-0197003 filed on December 26, 2024, in the Korean Intellectual Property Office, the entire disclosures of which are incorporated by reference herein.

### BACKGROUND OF THE DISCLOSURE

### 1. Field

This disclosure relates to an electrode transport system and a control method thereof.

### 2. Description of the Related Art

Secondary batteries can repeatedly undergo discharge, which converts chemical energy into electrical energy, and the reverse process of charging. Examples of secondary batteries include nickel-cadmium batteries, nickel-metal hydride batteries, lithium metal batteries, lithium-ion batteries, and lithium-ion polymer batteries.

Secondary batteries may be manufactured by repeatedly stacking electrodes and separators. This requires a process to transport the electrodes for battery production.

However, during electrode transporting, the electrodes may bend. Therefore, solutions to address this issue are required.

According to one aspect of the present disclosure, an object is to improve the quality of the electrodes.

According to another aspect of the present disclosure, an object is to reduce damage to the electrodes.

According to another aspect of the present disclosure, an object is to increase the productivity of the electrodes.

Meanwhile, the present invention according to the present disclosure may be widely applied in the fields of electric vehicles, battery charging stations, energy storage systems, and other green technologies such as photovoltaics and wind power that utilize battery cells. Furthermore, the present invention may be used in eco-friendly mobility, including electric vehicles and hybrid vehicles, to prevent climate change by suppressing air pollution and green-house gas emissions.

### SUMMARY OF THE DISCLOSURE

An electrode transport system according to an embodiment of the present disclosure may comprise: a first transport device for transporting the electrode; a first plate onto which the electrode transported from the first transport device is placed; a camera positioned spaced apart from the side of the first plate opposite the side where the electrode is placed and shooting the electrode placed on the first plate; and a support part included within the shooting region of the camera and forming a portion of the first plate, wherein the support part may be formed of a material to transmit at least a portion of light within a wavelength range detectable by the camera.

In an embodiment, the electrode transport system may further comprise: a control device, wherein the control device may control the first plate to adjust the alignment state of the electrode by comparing the alignment information of the electrode confirmed through the camera with a preset alignment information.

In an embodiment, the preset alignment information may be information regarding the position of preset reference points corresponding to each of the vertices of the electrode.

In an embodiment, the first transport device may include a second plate including air holes for adsorbing or separating the electrode; and a driving unit for moving the second plate.

In an embodiment, the first plate may include air holes for adsorbing the electrode placed at the second plate.

In an embodiment, the second plate may move toward to the first plate to adsorb the electrode adsorbed in the air holes of the second plate onto the air holes of the first plate.

In an embodiment, the second plate may move away from the first plate after the electrode is absorbed onto the air holes of the first plate.

In an embodiment, a portion of the second plate facing the support part may be formed of the material to transmits at least a portion of light in the wavelength range detectable by the camera.

In an embodiment, the area of the first plate may be equal to or greater than the area of the second plate.

In an embodiment, the electrode transport system may further comprise: a second transport device for transporting the electrodes to a stacking device for stacking the electrodes.

In an embodiment, the second transport device may include a third plate including air holes arranged to absorb or separate the electrode placed on the first plate and a driving unit for moving the third plate.

In an embodiment, the camera may be provided in a plurality and the cameras includes a first camera and a second camera.

In an embodiment, the support part may include a first support part and a second support part, the first support part forms a portion of the shooting region of the first camera on the first plate, and the second support part forms a portion of the shooting region of the second camera on the first plate.

In an embodiment, the first plate may further include a body part between the first support part and the second support part, and the body part is formed of the material to transmit at least a portion of light within a wavelength range detectable by the camera.

A control method for an electrode transport system, including a first transport device for transporting the electrode, a first plate onto which the electrode transported from the first transport device is placed, a camera positioned spaced apart from the side of the first plate opposite the side where the electrode is placed and shooting the electrode placed on the first plate; and a support part included within the shooting region of the camera and forming a portion of the first plate, may comprise: a step of placing the electrode from an electrode supply device, where the electrode is placed, onto the first plate through the first transport device; a step of confirming alignment information of the electrode through the camera; and a step of adjusting the alignment state of the electrode by comparing the alignment information of the electrode with a preset alignment information, wherein the support part may be formed of a material to transmit at least a portion of light within a wavelength range detectable by the camera.

According to an embodiment of the present disclosure, the quality of the electrodes may be improved.

According to another embodiment of the present disclosure, damage to the electrode may be reduced.

According to another embodiment of the present disclosure, productivity of the electrodes may be increased.

### BRIEF DESCRIPTION OF THE DRAWINGS

FIG. 1 is a block diagram schematically illustrating an electrode transport system according to the present disclosure.

FIG. 2A is an example illustrating an electrode supply device according to the present disclosure.

FIG. 2B is another example illustrating the electrode supply device according to the present disclosure.

FIG. 3 is a drawing schematically illustrating a first transport device according to the present disclosure.

FIG. 4 is a schematic diagram illustrating an alignment device according to the present disclosure.

FIG. 5 is a view showing the first transport device descending toward the alignment device.

FIG. 6 is a view showing the electrode, the first plate, and the second plate as seen in one direction in FIG. 5.

FIG. 7A is a diagram illustrating the operation of the control device according to present disclosure comparing the electrode alignment information with the preset alignment information.

FIG. 7B is a diagram illustrating the operation of the control device according to the present disclosure comparing the electrode alignment information with a preset alignment information.

FIG. 8 is an example illustrating a first plate according to the present disclosure.

FIG. 9 is another example illustrating the first plate according to the present disclosure.

FIG. 10 is a flowchart illustrating an example of a control method for an electrode transport system according to the present disclosure.

FIG. 11 is a flowchart illustrating another example of the control method for the electrode transport system according to the present disclosure.

### DETAILED DESCRIPTION

Specific terms used herein are for convenience of description only and are not intended to limit the scope of the exemplary embodiments.

For example, expressions such as "same" and "identical" indicate not only strictly identical states but also states where tolerances exist or where differences exist to the extent that the same function is achieved.

Expressions indicating relative or absolute arrangement, such as "in any direction," "along any direction," "parallel," "perpendicular," "towards the center," "concentric," or "coaxial," indicate not only strictly such arrangement but also a state where there is a relative displacement with tolerances, or angles or distances that achieve the same function.

The use of terms such as 'first, second, third' preceding components mentioned below is solely to avoid confusion regarding the components being referred to and is unrelated to any order, importance, or master-servant relationship between the components. For example, an invention may be implemented that includes only the second component without the first component.

Unless the context clearly indicates otherwise, singular expressions used in this specification may include plural expressions.

The following describes in detail a preferred embodiment of the present disclosure with reference to the accompanying drawings. The configuration of the apparatus and the control method described below are intended to illustrate the embodiment of the present disclosure and are not intended to limit the scope of the present disclosure. Reference numbers used throughout the specification denote the same components.

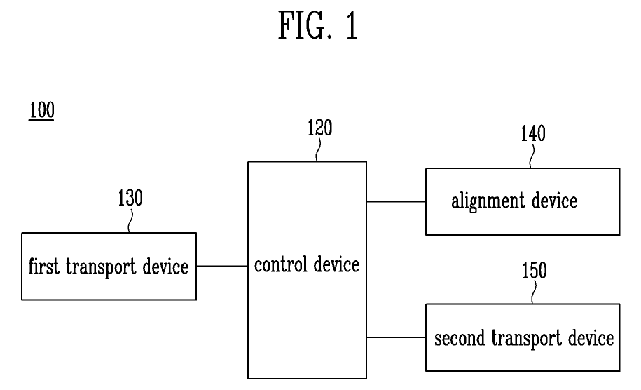

FIG. 1 is a block diagram schematically illustrating an electrode transport system according to the present disclosure.

In one embodiment, an electrode transport system 100 may comprise: a first transport device 130 for transporting the electrode 201; a first plate 420 onto which the electrode 201 transported from the first transport device 130 is placed; a camera positioned spaced apart from the side of the first plate 420 opposite the side where the electrode 201 is placed and shooting the electrode 201 placed on the first plate 420; and a support part included within the shooting region of the camera and forming a portion of the first plate 420, wherein the support part may be formed of a material to transmit at least a portion of light within a wavelength range detectable by the camera.

In one embodiment, the electrode transport system 100 may further comprise a control device 120, wherein the control device 120 may control the first plate 420 to adjust the alignment state of the electrode 201 by comparing the alignment information of the electrode 201 confirmed through the camera with a preset alignment information.

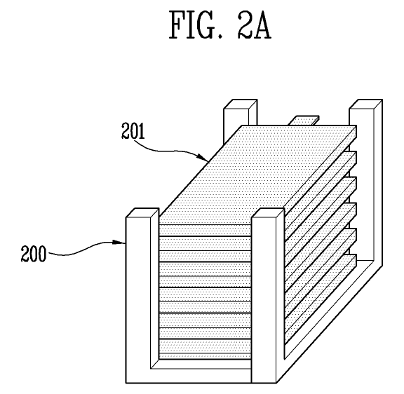

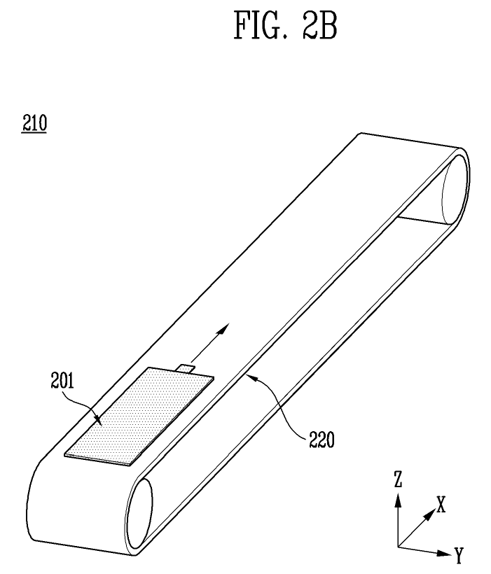

For example, referring to FIG. 1, the electrode transport system 100 includes: a first transport device 130 for transporting an electrode 201 from an electrode supply device (200 in FIG. 2A, 210 in FIG. 2B) where the electrode 201 is placed; an alignment device 140 for adjusting the alignment state of the electrode 201, a second transport device 150 for transporting the electrode 201 with its alignment state adjusted to a stacking device for stacking, and a control device 120 for controlling the electrode transport system 100. According to one embodiment, the control device 120 can control the first transport device 130, the alignment device 140, and the second transport device 150. The control device 120 can control the overall operations performed by the first transport device 130, the alignment device 140, and the second transport device 150. According to one embodiment, the movement of the first transport device 130, the second transport device 150, and the alignment device 140 may be controlled.

The control device 120 may be implemented as a separate device from the first transport device 130, the second transport device 150, and the alignment device 140. Alternatively, the control device 120 may be implemented as a device included within each of the first transport device 130, the second transport device 150, and the alignment device 140.

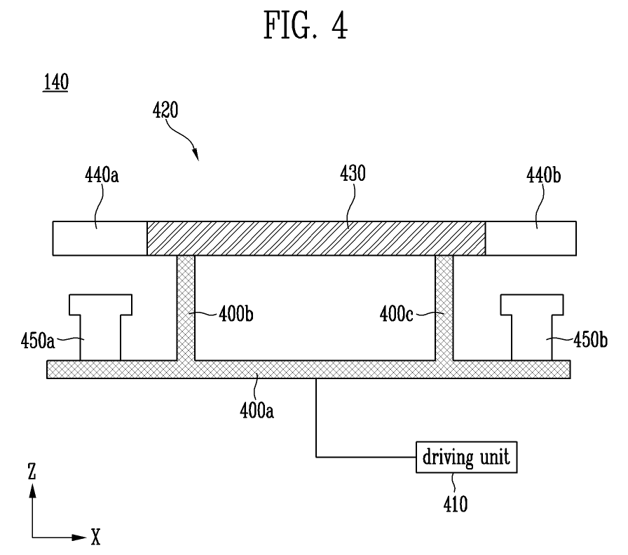

According to one embodiment, the electrode transport system 100 may represent a system for transporting an electrode 201 from an electrode supply device 200, 210 where the electrode 201 is positioned to a stacking device for stacking the electrode 201. According to one embodiment, even if curl has occurred at the tips of the electrode 201, the alignment device 140 can detach the electrode 201 from the transport device (e.g., a first transport device 130 and can flatten the entire surface of the electrode 201 without the influence of the curl by suctioning and pressing the corners of the electrode 201 placed on the alignment device 140. Accordingly, in one embodiment, the alignment state of the electrode 201 may be accurately determined by the camera (450a, 450b in FIG. 4) included in the alignment device 140, unaffected by the curl of the electrode 201. According to one embodiment, the electrode transport system 100 may represent a system that transports the electrode 201 supplied from the electrode supply device 200, 210 to the stacking device after adjusting the alignment state of the electrode at the alignment device 140.

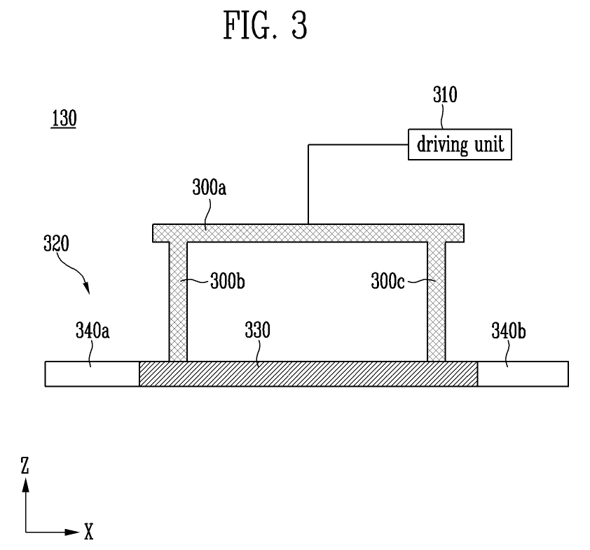

According to one embodiment, the first transport device 130 can move in a first predetermined direction (the X-axis direction in FIG. 3), a second direction (the Z-axis direction in FIG. 3), or a third direction (the Y-axis direction) perpendicular to both the first and second directions (the Z-axis direction in FIG. 3). According to one embodiment, the preset position of the first transport device 130 may represent a standby position when the first transport device 130 is not driven.

According to one embodiment, the first transport device 130 can rise or descend along the second direction to transport an electrode 201 placed in the electrode supply device 200, 210. According to one embodiment, the first transport device 130 may be referred to as a pick and place (PNP) device.

According to one embodiment, the first transport device 130 can descend along the second direction toward the electrode supply device 200, 210 to pick up an electrode 201 placed on the electrode supply device 200, 210. After picking up the electrode 201, the first transport device 130 can move up and down along a second direction away from the electrode supply device 200, 210.

According to one embodiment, the first transport device 130 can move toward the alignment device 140.

According to one embodiment, the first transport device 130 can descend along a second direction to detach the electrode 201 from the alignment device 140. The first transport device 130 can ascend or descend along the second direction after attaching or detaching the electrode 201 to the alignment device 140. According to one embodiment, the first transport device 130 can move to a preset position.

According to one embodiment, the alignment device 140 can confirm alignment information of the electrode 201 transported by the first transport device 130. For example, the alignment device 140 can acquire an image shot of the electrode 201 through a camera (450a, 450b in FIG. 4) included in the alignment device 140.

According to one embodiment, the control device 120 can compare the alignment information of the electrode 201 with the preset alignment information. According to one embodiment, the control device 120 can compare the alignment information of the electrode 201 with the preset alignment information using the image shot through the cameras 450a, 450b.

In one embodiment, the preset alignment information may be information regarding the position of preset reference points corresponding to each of the vertices of the electrode.

For example, if the control device 120 confirms that the alignment information and the preset alignment information are different, it can control the alignment device 140 so that the alignment information of the electrode 201 becomes the preset alignment information. According to one embodiment, the preset alignment information may include information regarding the positions of preset reference points corresponding to each vertex of the electrode 201. According to one embodiment, the preset alignment information may also include information regarding the positions of reference lines corresponding to each of the multiple edges of the electrode 201. For example, the preset alignment information may be automatically set by the control device 120 or set by the user via a separate input device included in the electrode transport system 100.

According to one embodiment, the control device 120 can adjust the alignment state of the electrode 201 by moving the alignment device 140 so that the alignment information of the electrode 201 corresponds to the preset alignment information, based on confirming that the alignment information of the electrode 201 and the preset alignment information are different from each other. For example, the control device 120 may control the alignment device 140 to rotate so that the alignment information of the electrode 201 corresponds to the preset alignment information.

According to one embodiment, after adjusting the alignment state of the electrode 201, the alignment device 140 can reacquire an image of the electrode 201 shot through the cameras 450a, 450b. According to one embodiment, the control device 120 can compare the adjusted alignment information of the electrode 201 with the preset alignment information using the reshot image. According to one embodiment, if the adjusted alignment information differs from the preset alignment information, the control device 120 can control the alignment device 140 to readjust the alignment state of the electrode 201. According to one embodiment, if the adjusted alignment information is identical to the preset alignment information, the control device 120 can control the second transport device 150 to move from the preset position of the second transport device 150 to the alignment device 140.

According to one embodiment, after the alignment state of the electrode 201 is adjusted, the second transport device 150 can move from its preset position to the alignment device 140 to transport the electrode 201. According to one embodiment, the preset position of the second transport device 150 may represent a standby position when the second transport device 150 is not driven. According to one embodiment, the second transport device 150 may be referred to as a pick and place (PNP) device.

According to one embodiment, the second transport device 150 may ascend or descend along a second direction to transport an electrode 201 placed on an electrode supply device 200, 210.

According to one embodiment, the second transport device 150 can descend along the second direction to pick up the electrode 201 from the alignment device 140. According to one embodiment, the second transport device 150 can ascend or descend along the second direction after picking up the electrode 201 from the alignment device 140.

According to one embodiment, the electrode transport system 100 may include a second transport device 150 for transporting the electrodes 2001 to a stacking device for stacking the electrodes 201.

For example, the second transport device 150 may move toward the stacking device.

According to one embodiment, the second transport device 150 may include a third plate including air holes arranged to absorb or separate the electrode 201 placed on the first plate 420 and a driving unit for moving the third plate.

For example, the second transport device 150 can descend toward the stacking device along the second direction to detach the electrode 201 from the stacking device. According to one embodiment, after attaching or detaching the electrode 201 to the stacking device, the second transport device 150 can move up or down along the second direction to move away from the stacking device. According to one embodiment, the second transport device 150 may move to a preset position of the second transport device 150 after moving up and down along the second direction.

FIG. 2A is an example illustrating an electrode supply device according to the present disclosure.

Referring to FIG. 2A, the electrode supply device 200, 210 according to the present disclosure may include a device capable of stacking and accommodating electrodes 201 internally. For example, the electrode supply device may include a magazine 200.

The magazine 200 may include a plurality of support frames to form an internal space capable of stacking electrodes 201. The plurality of support frames may serve to secure the stacked electrodes 201 to prevent movement.

The first transport device 130 can transport the electrode 201 positioned at the topmost layer within the magazine 200 to the alignment device 140.

FIG. 2B is another example illustrating the electrode supply device according to the present disclosure.

Referring to FIG. 2B, the electrode supply device may include a device that moves the electrode 201 in one direction. For example, the electrode supply device may include a Linear Motion System (LMS) 210.

The LMS 210 may include a transport plate 220 where the electrode 201 is placed, rollers, and a drive unit (e.g., a motor). The LMS 210 may transport the transport plate 220 and the electrode 201 by rotating the rollers.

The transport plate 220 may be moved along a predetermined first direction (X-axis direction.

The LMS 210 can stop the rotation of the rollers when the transport plate 220 reaches a preset position.

The first transport device 130 may transport the electrode 201 placed on the transport plate 220 to the alignment device 140.

FIG. 3 is a drawing schematically illustrating a first transport device according to the present disclosure.

Referring to FIG. 3, the first transport device 130 according to the present disclosure may transport the electrode 201 placed in the magazine 200 outside the magazine 200. The first transport device 130 may also transport the electrode 201 placed in the LMS 210 to the outside of the LMS 210. The first transport device 130 may be referred to as a pick and place (PNP) device.

According to one embodiment, the first transport device 130 may include a second plate 320 including air holes for adsorbing or separating the electrode; and a driving unit 310 for moving the second plate 320.

For example, the first transport device 130 may include a second plate 320, a driving unit 310, and a support frame 300a, 300b, 300c connecting the second plate 320 and the driving unit 310.

According to one embodiment, the driving unit 310 may provide a driving force capable of moving the second plate 320. The driving unit 310 may include a motor. For example, the second plate 320 may be moved in a preset first direction (X-axis direction), a second direction (Z-axis direction) perpendicular to the first direction and along which the second plate 320 ascends and descends, or a third direction (Y-axis direction) perpendicular to both the first and second directions.

According to one embodiment, the top surface of the second plate 320 may be connected to a support frame 300a, 300b, 300c. According to one embodiment, the length of the support frame 300a in the first direction (X-axis direction) may be shorter than the length of the second plate 320 in the first direction (X-axis direction).

According to one embodiment, the first plate 420 may include air holes for adsorbing the electrode placed on the second plate 320.

According to one embodiment, the second plate 320 may move toward to the first plate to adsorb the electrode adsorbed in the air holes of the second plate onto the air holes of the first plate 420.

According to one embodiment, the second plate 320 may move away from the first plate after the electrode is absorbed onto the air holes of the first plate 420.

For example, the bottom surface of the second plate 320 may form air holes capable of adsorbing an electrode. The number of air holes may be formed as a plurality. The air holes may be formed as circular or polygonal, but the shape of the air holes is not limited thereto and may be formed in various shapes.

According to one embodiment, the first transport device 130 may further include an ejector that controls the pressure of the air holes. According to one embodiment, when the pressure of the air holes is lower than a reference pressure, an electrode may be adsorbed onto the bottom surface of the second plate 320. According to one embodiment, if the pressure in the air hole is not lower than a reference pressure, the electrode may not be adsorbed to the bottom surface of the second plate 320. For example, the reference pressure may represent a pressure capable of adsorbing the electrode 201 and may be 1 atmosphere, but is not limited thereto and may be set to various values.

Alternatively, according to one embodiment, an adsorption pad capable of adsorbing the electrode may be attached to the bottom surface of the second plate 320.

According to one embodiment, the second plate 320 may include an region 340a, 340b formed from a material that transmits at least a portion of the wavelength range detectable by the camera (450a, 450b of FIG. 4) and is included within the camera's (450a, 450b of FIG. 4) shooting region.

According to one embodiment, a portion of the second plate 320 facing the support part is formed of the material to transmits at least a portion of light in the wavelength range detectable by the camera.

For example, the second plate 320 may include a region 330 formed of a material that transmits at least a portion of light in a wavelength range different from the wavelength range detectable by the camera (450a, 450b in FIG. 4).

According to one embodiment, the length of the region 330 formed of a material that transmits at least a portion of light of a wavelength range different from the wavelength range detectable by the camera (450a, 450b in FIG. 4) along the first direction (X-axis direction) may be longer than the length of each of the regions 340a, 340b formed of a material that transmits at least a portion of light of a wavelength range detectable by the camera (450a, 450b in FIG. 4) along the first direction (X-axis direction).

According to one embodiment, the region 340a, 340b formed of a material transmitting at least a portion of light in the wavelength range detectable by the camera (450a, 450b in FIG. 4) may represent the area where the backlight is arranged on the second plate 320. For example, the backlight may include any one of a cold cathode fluorescent lamp, an external electrode fluorescent lamp, a light emitting diode, an injection electroluminescence, an flat fluorescent lamp, or an hot cathode fluorescent lamp.

FIG. 4 is a schematic diagram illustrating an alignment device according to the present disclosure.

Referring to FIG. 4, the alignment device 140 can adjust the alignment state of the electrodes. The alignment device 140 may include a cameras 450a, 450b, a first plate 420, a driving unit 410, and a support frame 400a, 400b, 400c connecting the driving unit 410 and the first plate 420.

According to one embodiment, the driving unit 410 can provide a driving force capable of moving the first plate 420. The driving unit 410 may include a motor. For example, the first plate 420 may be moved in a preset first direction (X-axis direction), or in a third direction (Y-axis direction) perpendicular to both the first and second directions. The first plate 420 may be rotated about the second direction (Z-axis direction).

According to one embodiment, the top surface of the first plate 420 may be connected to a support frame 400a, 400b, 400c.

According to one embodiment, the first plate 420 may include air holes for adsorbing the electrode placed on the second plate.

For example, the top surface of the first plate 420 may form air holes capable of adsorbing an electrode. The number of air holes may be formed as a plurality. The air holes may be formed as circular or polygonal, but the shape of the air holes is not limited thereto and may be formed in various shapes.

According to one embodiment, the alignment device 140 may further include an ejector for controlling the pressure of the air holes. According to one embodiment, if the pressure of the air holes is lower than a reference pressure, an electrode may be adsorbed onto the top surface of the first plate 420. According to one embodiment, if the pressure in the air hole is not lower than a reference pressure, an electrode may not be adsorbed onto the top surface of the first plate 420. For example, the reference pressure may represent a pressure capable of adsorbing the electrode 201 and may be 1 atmosphere, but is not limited thereto and may be set to various values.

Alternatively, according to one embodiment, an adsorption pad capable of adsorbing the electrode may be attached to the top surface of the first plate 420.

According to one embodiment, the electrode may be positioned through air holes formed in the top surface of the first plate 420.

According to one embodiment, the cameras 450a, 450b is spaced apart in the opposite direction from the direction in which the electrodes 201 are arranged, enabling it to shoot images of the electrodes 201 arranged on the first plate 420. According to one embodiment, the cameras 450a, 450b can shoot the alignment state of the electrodes 201 to verify the arrangement information. For example, the cameras 450a, 450b may be referred to as a vision camera.

According to one embodiment, the first plate 420 is included within the shooting region of the cameras 450a, 450b and may include support parts 440a, 440b forming a portion of the first plate 420. The support parts 440a, 440b may be formed from a material that transmits at least a portion of the wavelength range detectable by the cameras 450a, 450b.

According to one embodiment, the shooting region of the cameras 450a, 450b may be identical to the camera's field of view (FOV) region or may be an area included within the camera's FOV area. According to one embodiment, the FOV region of the cameras 450a, 450b may represent the angle of view that the cameras 450a, 450b can shoot.

According to one embodiment, the first plate 420 may further include a body part 430 between the first support part 440a and the second support part 440b, and the body part 430 is formed of the material to transmit at least a portion of light within a wavelength range detectable by the camera.

For example, the first plate 420 may not be included within the shooting region of the cameras 450a, 450b and may include a body part 430 forming a portion of the first plate 420. According to one embodiment, the body part 430 may be formed of a material that transmits at least some light of a wavelength range different from the wavelength range detectable by the cameras 450a, 450b.

According to one embodiment, the cameras 450a, 450b may be provided in plurality. The cameras 450a, 450b may include a first camera 450a and a second camera 450b.

According to one embodiment, the support part 440a, 440b may include a first support part 440a and a second support part 440b, the first support part 440a may form a portion of the shooting region of the first camera 450a on the first plate, and the second support part 440b may form a portion of the shooting region of the second camera 450b on the first plate.

For example, the support parts 440a, 440b may include a first support part 440a and a second support part 440b.

According to one embodiment, the first support part 440a may form part of the shooting region of the first camera 450a. According to one embodiment, the first support part 440a may be formed of a material that transmits at least a portion of light in the wavelength range detectable by the first camera 450a.

According to one embodiment, the second support part 440b may form part of the shooting region of the second camera 450b. According to one embodiment, the second support part 440b may be formed of a material that transmits at least some of the light in the wavelength range detectable by the second camera 450b.

According to one embodiment, the length of the body part 430 along the first direction (X-axis direction) may be longer than the length of each support part 440a, 440b along the first direction (X-axis direction).

According to one embodiment, the support parts 440a, 440b may also represent regions where a backlight is arranged on the first plate 420. For example, the backlight may include any one of a cold cathode fluorescent lamp, external electrode fluorescent lamp, light emitting diode, injection electroluminescence, flat fluorescent lamp, or hot cathode fluorescent lamp.

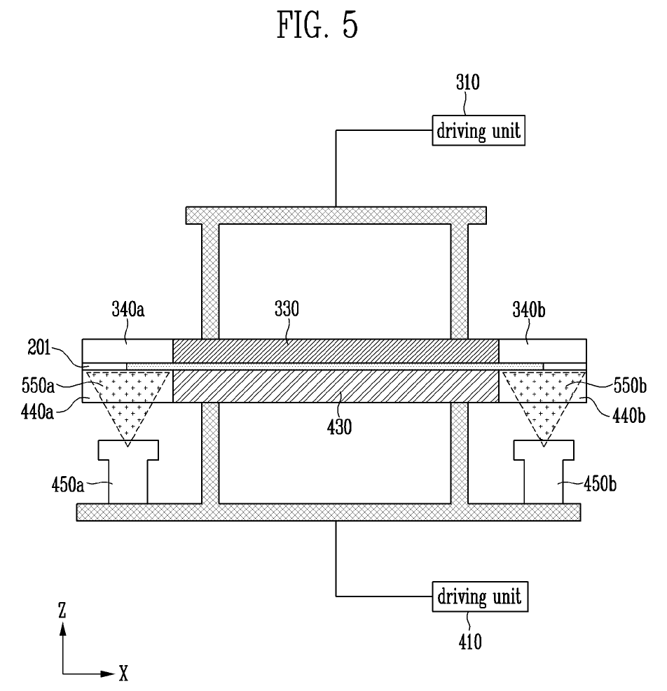

FIG. 5 is a view showing the first transport device descending toward the alignment device.

Referring to FIG. 5, according to one embodiment, to place the electrode 201 adsorbed on the second plate 320 onto the first plate 420, the first transport device 130 can descend in a direction approaching the second plate 320. The direction toward the second plate 320 may indicate the direction opposite to the second direction (Z-axis direction), i.e., the -Z-axis direction.

According to one embodiment, the cameras 450a, 450b may be disposed on the bottom surface of the first plate 420.

According to one embodiment, an area 340a of the second plate 320 that is included within the shooting region 550a of the first camera 450a and formed of a material that transmits at least a portion of light in a wavelength range detectable by the first camera 450a may face the first support part 440a. Through this, the first camera 450a may shoot the electrode 201 placed on the top surface of the first plate 420.

According to one embodiment, the second plate 320 includes a region 340b formed of a material that transmits at least a portion of light within a wavelength range detectable by the second camera 450b, which region is included within the shooting region 550b of the second camera 450b and may face the second support part 440b. Through this, the second camera 450b may shoot the electrode 201 placed on the top surface of the first plate 420.

According to one embodiment, among the second plates 320, a region 330 formed of a material that is not included in the shooting region 550a of the first camera 450a and the shooting region 550b of the second camera 450b and transmits at least a portion of light of a wavelength range different from the wavelength range detectable by the first camera 450a and the second camera 450b may face the body part 430.

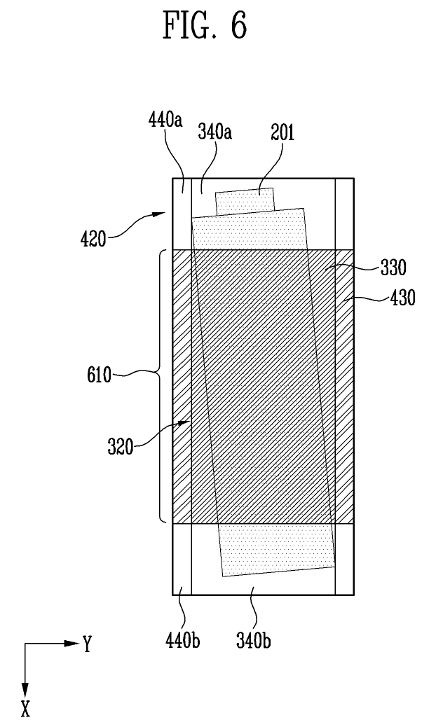

FIG. 6 is a view showing the electrode, the first plate, and the second plate as seen in one direction in FIG. 5.

More specifically, FIG. 6 is a view looking along a direction (-Z-axis direction) symmetrical to the second direction (Z-axis direction) in FIG. 5.

According to one embodiment, the area of the first plate 420 is equal to or greater than the area of the second plate 320.

For example, the area of the first plate 420 may be greater than the area of the second plate 320.

According to one embodiment, the length of the first plate 420 along the first direction (X-axis direction) may be the same as the length of the second plate 320 along the first direction (X-axis direction). According to one embodiment, the length of the first plate 420 along the first direction (X-axis direction) and the length of the second plate 320 along the first direction (X-axis direction) may be greater than the length of the electrode 201 along the first direction (X-axis direction).

According to one embodiment, the length of the first plate 420 along the third direction (Y-axis direction) may be greater than the length of the second plate 320 along the third direction (Y-axis direction). According to one embodiment, the length of the first plate 420 in the third direction (Y-axis direction) and the length of the second plate 320 in the third direction (Y-axis direction) may be greater than the length of the electrode 201 in the third direction (Y-axis direction).

According to one embodiment, since the first plate 420 and the second plate 320 may be formed of a material that may transmit light of a wavelength range that may be detected by the cameras 450a, 450b in a region corresponding to the field of view of the camera 450a, 450b that shoots the electrode 201, there is an effect of being able to accurately confirm the arrangement state or information of the electrode 201.

According to one embodiment, regions 610 of the first plate 420 and second plate 320 other than those corresponding to the field of view of the cameras 450a, 450b may be formed from a material capable of transmitting light in a wavelength range different from that detectable by the cameras 450a, 450b.

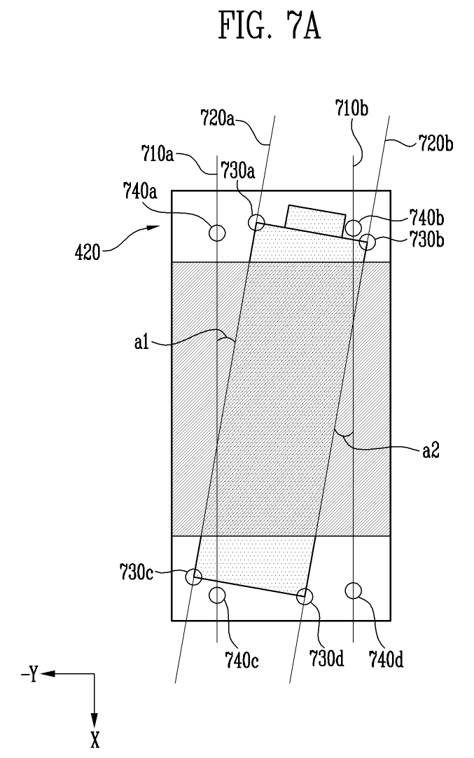

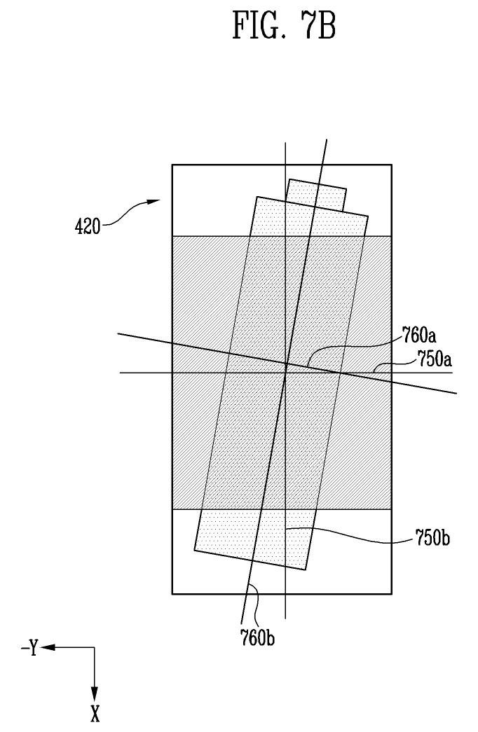

FIG. 7A is a diagram illustrating the operation of the control device according to present disclosure comparing the electrode alignment information with the preset alignment information.

Referring to FIG. 7A, according to one embodiment, the control device 120 can confirm an image shot by the cameras 450a, 450b of the electrodes 201 placed on the first plate 420. For convenience of explanation, the second plate 320 is omitted in FIG. 7A.

According to one embodiment, the control device 120 can use the image to compare the arrangement information of the electrodes 201 with the preset arrangement information.

According to one embodiment, the control device 120 can compare a plurality of vertices 730a, 730b, 730c, 730d of the electrode 201 and reference points 740a, 740b, 740c, 740d corresponding to the plurality of vertices 730a, 730b, 730c, 730d, respectively.

For example, the control device 120 can compare the first vertex 730a of the electrode 201 with the first reference point 740a corresponding to the first vertex 730a. The control device 120 can determine whether the distance between the first vertex 730a and the first reference point 740a is less than a specified first distance.

For example, the control device 120 can compare a second vertex 730b of the electrode 201 with a second reference point 740b corresponding to the second vertex 730b. The control device 120 can determine whether the distance between the second vertex 730b and the second reference point 740b is less than a specified second distance.

For example, the control device 120 can compare the third vertex 730c of the electrode 201 with the third reference point 740c corresponding to the third vertex 730c. The control device 120 can determine whether the distance between the third vertex 730c and the third reference point 740c is less than a specified third distance.

For example, the control device 120 can compare the fourth vertex 730d of the electrode 201 with the fourth reference point 740d corresponding to the fourth vertex 730d. The control device 120 can determine whether the distance between the fourth vertex 730d and the fourth reference point 740d is less than a specified fourth distance. The control device 120 can determine whether the distance between the first vertex 730a and the first reference point 740a is less than a specified first distance, the distance between the second vertex 730b and the second reference point 740b is less than a specified second distance, the distance between the third vertex 730c and the third reference point 740c is less than a specified third distance, and the distance between the fourth vertex 730d and the fourth reference point 740d is less than a specified fourth distance.

For example, the specified first distance, specified second distance, specified third distance, and specified fourth distance may be identical to each other or may differ from each other. The specified first distance, specified second distance, specified third distance, and specified fourth distance may each represent a distance for determining whether to adjust the alignment state of the electrode 201. The specified first distance, specified second distance, specified third distance, and specified fourth distance may be set by the user via a separate input device included in the electrode transport system 100, or may be automatically set by the control device 120.

According to one embodiment, the control device 120 may compare lines 720a, 720b extending from the edge along the longitudinal direction of the electrode 201 with reference lines 710a, 710b corresponding to the lines 720a, 720b extending from the edge.

For example, the control device 120 can determine the angle a1 between the line 720a extending the first edge and the first reference line 710a corresponding to the line 720a extending the first edge. The control device 120 can determine whether the angle a1 between the line 720a extending from the first edge and the first reference line 710a corresponding to the line 720a extending from the first edge is smaller than a specified first angle.

For example, the control device 120 can determine the angle a2 between the line 720b extending from the second edge and the second reference line 710b corresponding to the line 720b extending from the second edge. The control device 120 can determine whether the angle a2 between the line 720b extending from the second edge and the second reference line 710b corresponding to the line 720b extending from the second edge is smaller than a specified second angle.

The control device 120 can rotate the first plate 420 such that the angle a1 is smaller than a specified first angle and the angle a2 is smaller than a specified second angle.

For example, the specified first angle and the specified second angle may be the same or different from each other. The specified first angle and the specified second angle may each represent a distance for determining whether to adjust the alignment state of the electrodes 201. The specified first angle and the specified second angle may be set by a user via a separate input device included in the electrode transport system 100, or may be set automatically by the control device 120.

The control device 120 determines whether to adjust the alignment state of the electrodes 201 based on the distances between the reference points 740a, 740b, 740c, 740d corresponding to the multiple vertices 730a, 730b, 730c, 730d of the electrodes 201 and the multiple vertices 730a, 730b, 730c, 730d are each less than a specified distance, the angle a1 between the first reference line 710a corresponding to the line 720a extending the first edge and the second reference line 710b corresponding to the line 720b extending the second edge is less than a specified first angle, and the angle a2 between the second reference line 710b corresponding to the line 720b extending the second edge and the second reference line 710b is smaller than a specified second angle, the movement of the second transport device 150 may be controlled to transport the electrode 201 to the stacking device.

FIG. 7B is a diagram illustrating the operation of the control device according to the present disclosure comparing the electrode alignment information with a preset alignment information.

Referring to FIG. 7B, according to one embodiment, the control device 120 can confirm an image shot of the electrode 201 placed on the first plate 420 through the cameras 450a, 450b. For ease of description, the second plate 320 is omitted in FIG. 7B.

According to one embodiment, the control device 120 can use the image to compare the arrangement information of the electrodes 201 with the preset arrangement information.

According to one embodiment, the control device 120 can compare the preset reference lines 750a, 750b with the reference lines 760a, 760b for the electrodes 201.

The reference lines 760a, 760b for the electrodes 201 may represent the centerlines of the electrodes 201.

According to one embodiment, the control device 120 can rotate the first plate 420 so that the preset reference lines 750a, 750b and the reference lines 760a, 760b for the electrode 201 match each other.

According to one embodiment, if the control device 120 determines that the preset reference lines 750a, 750b and the reference lines 760a, 760b for the electrode 201 match each other, it can control the movement of the second transport device 150 to transport the electrode 201 to the stacking device.

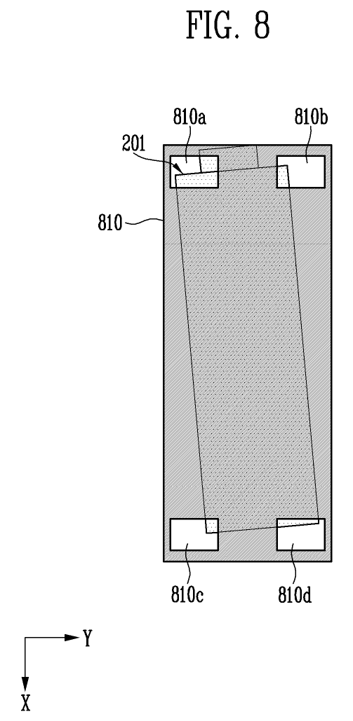

FIG. 8 is an example illustrating a first plate according to the present disclosure.

Referring to FIG. 8, according to one embodiment, the first plate 810 according to the present disclosure may be formed from a material capable of transmitting light in a wavelength range different from the wavelength range detectable by the cameras 450a, 450b.

According to one embodiment, holes 810a, 810b may be formed in the first plate 810 in regions corresponding to a preset region of interest (ROI) of the camera 450a. For example, the preset region of interest may represent the camera's 450a field of view (FOV) region or a preset area included within the camera's 450a FOV region.

According to one embodiment, holes 810c, 810d may be formed in the region corresponding to the preset region of interest of the camera 450b on the first plate 810. For example, the preset region of interest may represent the camera's 450b FOV region or a preset region included within the camera's 450b FOV region.

According to one embodiment, the second plate (not shown) according to the present disclosure may be formed of a material capable of transmitting light in a wavelength range different from the wavelength range detectable by the cameras 450a, 450b.

According to one embodiment, holes may be formed in the second plate (not shown) in regions corresponding to the holes 810a, 810b of the first plate 810. This allows camera 450a to shoot the electrode 201 placed on the top surface of the first plate 810.

According to one embodiment, holes may be formed in the second plate (not shown) in regions corresponding to the holes 810c, 810d of the first plate 810. This allows the camera 450b to shoot the electrode 201 placed on the top surface of the first plate 810.

Although the holes in the first plate 810 are shown as rectangular in FIG. 8, the shape of the holes is not limited thereto. Furthermore, the number of holes shown in FIG. 8 is not limiting, and the holes formed in the first plate 810 may be formed in various numbers.

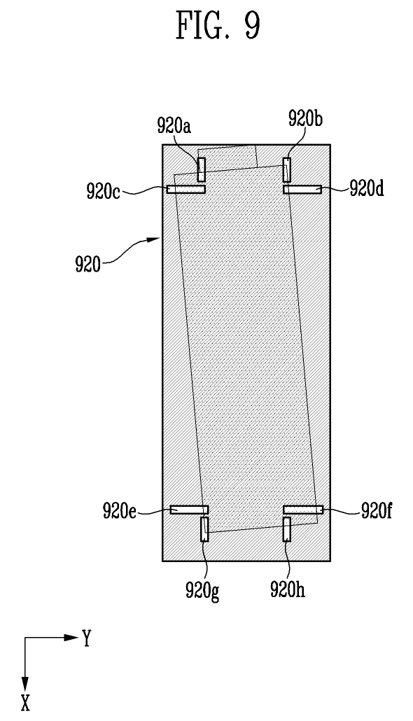

FIG. 9 is another example illustrating the first plate according to the present disclosure.

Referring to FIG. 9, according to one embodiment, the first plate 920 of the present disclosure may be formed from a material capable of transmitting light in a wavelength range different from the wavelength range detectable by the cameras 450a, 450b.

According to one embodiment, holes 920a, 920b, 920c, 920d may be formed in the first plate 920 in regions corresponding to a preset region of interest for the camera 450a. For example, the preset region of interest for camera 450a may represent an area included within the camera's FOV. For example, the preset region of interest may represent an area within the camera's FOV that is set by the user.

According to one embodiment, holes 920e, 920f, 920g, 920h may be formed in the area of the first plate 810 corresponding to the preset region of interest of the camera 450b.

According to one embodiment, the second plate (not shown) according to the present disclosure may also be formed of a material capable of transmitting light in a wavelength range different from the wavelength range detectable by the cameras 450a, 450b.

According to one embodiment, holes may be formed in the second plate (not shown) in regions corresponding to the holes 920a, 920b, 920c, 920d of the first plate 920. This allows the camera 450a to shoot the electrode 201 placed on the top surface of the first plate 920.

According to one embodiment, holes may be formed in regions corresponding to the holes 920e, 920f, 920g, 920h of the first plate 920 among the second plates (not shown). This allows the camera 450b to shoot the electrode 201 placed on the top surface of the first plate 920.

Although the holes in the first plate 920 are shown as rectangular in FIG. 9, the shape of the holes is not limited to this. Furthermore, the number of holes formed in the first plate 920 is not limited to the number shown in FIG. 9 and may be formed in various numbers.

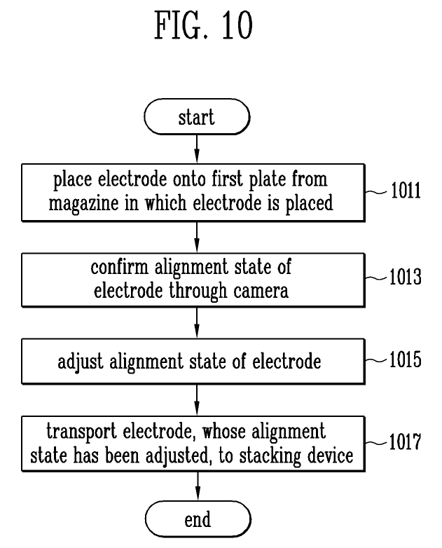

FIG. 10 is a flowchart illustrating an example of a control method for an electrode transport system according to the present disclosure.

Referring to FIG. 10, a control method for an electrode transport system 100, including a first transport device for transporting the electrode, a first plate onto which the electrode transported from the first transport device is placed, a camera positioned spaced apart from the side of the first plate opposite the side where the electrode is placed and shooting the electrode placed on the first plate; and a support part included within the shooting area of the camera and forming a portion of the first plate, may comprise: a step 1011 of placing the electrode 201 from an electrode supply device, where the electrode 201 is placed, onto the first plate 420 through the first transport device 130; a step 1013 of confirming alignment information of the electrode through the camera 450a, 450b; and a step of adjusting the alignment state of the electrode 201 by comparing the alignment information of the electrode with a preset alignment information, wherein the support part may be formed of a material to transmit at least a portion of light within a wavelength range detectable by the camera 450a, 450b.

For example, the control method for the electrode transport system 100 according to the present disclosure may include, in step 1011, placing an electrode 201 from a magazine 200 in which the electrode 201 is placed onto a first plate 420 via a first transport device 130. Alternatively, the control method for the electrode transport system 100 according to this disclosure may include, in step 1013, placing the electrode 201 from the LMS 210, where the electrode 201 is positioned, onto the first plate 420 via the first transport device 130.

The control method for the electrode transport system 100 according to the present disclosure may include, in operation 1013, a step of confirming the alignment state of the electrode 201 through the cameras 450a, 450b. The control method for the electrode transport system 100 according to the present disclosure may include a step of confirming the alignment state of the electrode 201 included in an image shot using the cameras 450a, 450b.

The step of confirming the alignment state of the electrode 201 through the cameras 450a, 450b according to the present disclosure, the stage of confirming the alignment state of the electrode 201 through the cameras 450a, 450b according to the present disclosure may include the step of confirming the alignment state of the electrode 201 contained in the image using images shot through the cameras 450a, 450b.450a, 450b to confirm the alignment state of the electrode 201.

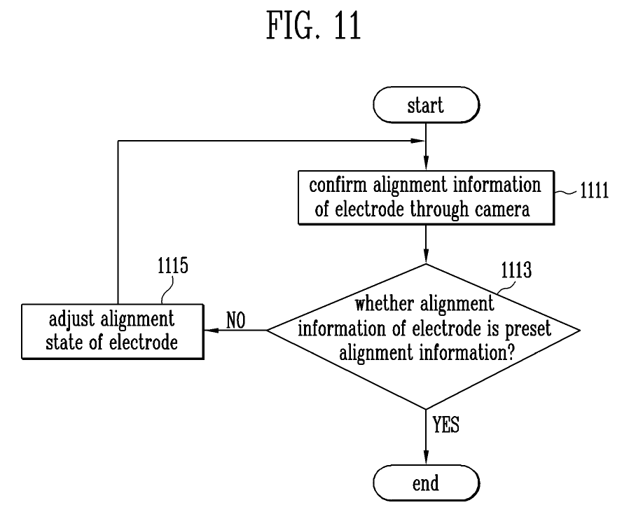

The control method for the electrode transport system 100 according to this disclosure may include, in operation 1015, a step of adjusting the alignment state of the electrode 201. The control method for the electrode transport system 100 according to the present disclosure may include a step of adjusting the alignment state of the electrode 201 by rotating the second plate 320 so that the alignment information of the electrode 201 becomes the preset alignment information. According to one embodiment, operation 1015 is described in detail in FIG. 11.

The control method for the electrode transport system 100 according to this disclosure may include, in operation 1017, transporting the electrode 201, whose alignment state has been adjusted, to the stacking device via the second transport device 150.

FIG. 11 is a flowchart illustrating another example of the control method for the electrode transport system according to the present disclosure.

More specifically, FIG. 11 is a flowchart illustrating in detail the operation of step 1015 in FIG. 10.

The control method for the electrode transport system 100 according to the present disclosure may include, in step 1111, a step of confirming the alignment state or alignment information of the electrode 201 through the cameras 450a, 450b.

The control method for the electrode transport system 100 according to this disclosure may include, in step 1113, a step of confirming whether the alignment information of the electrode 201 is preset alignment information. According to one embodiment, the preset alignment information may represent information regarding the positions of reference points corresponding to each vertex of the electrode 201. According to one embodiment, the preset alignment information may also represent information regarding the positions of reference lines corresponding to each of the multiple edges of the electrode 201. For example, the preset alignment information may be automatically set by the control device 120 or set by the user via a separate input device.

The control method for the electrode transport system 100 according to the present disclosure, when it is confirmed that the alignment information of the electrode 201 is the preset alignment information (step 1113-Yes), terminating the step of adjusting the alignment state of the electrode 201, and including a step of transferring the electrode 201 with its alignment state adjusted to the stacking device via the second transport device 150.

The control method for the electrode transport system 100 according to this disclosure may include, when it is confirmed that the alignment information of the electrode 201 is not the preset alignment information (step 1113-No), a step of adjusting the alignment state of the electrode 201 in Operation 1115. The control method for the electrode transport system 100 according to the present disclosure, when it is confirmed that the alignment information of the electrode 201 is not the preset alignment information (step 1113-No), control the first plate 420 to adjust the alignment state of the electrode 201 so that the alignment information of the electrode 201 becomes the preset alignment information.

The control method for the electrode transport system 100 according to this disclosure may, after adjusting the alignment state of the electrode 201, reconfirm the alignment information of the electrode 201 through the cameras 450a, 450b.

The control method for the electrode transport system 100 according to this disclosure can reconfirm whether the reconfirmed alignment information of the electrode 201 is the preset alignment information.

The control method for the electrode transport system 100 according to this disclosure may repeat operations 1111 to 1115 until the alignment information of the electrode 201 becomes the preset alignment information.

Alternatively, the control method of the electrode transport system 100 according to this disclosure may repeat and perform operations 1111 to 1115 a predetermined number of times. The control method for the electrode transport system 100 according to this disclosure may include a step of discarding the electrode 201 if the alignment information of the electrode 201 differs from the preset alignment information even after performing operations 1111 to 1115 a preset number of times.

The present disclosure may be practiced in various forms and modifications, and the scope of the claims is not limited to the specific embodiments described above. Therefore, if a modified embodiment includes the components of the claims of the present disclosure, it should be considered within the scope of the claims of the present disclosure.

What is claimed is:

1. An electrode transport system, comprising:
a first transport device for transporting the electrode;
a first plate onto which the electrode transported from the first transport device is placed;
a camera positioned spaced apart from the side of the first plate opposite the side where the electrode is placed and shooting the electrode placed on the first plate; and
a support part included within the shooting region of the camera and forming a portion of the first plate,
wherein the support part is formed of a material to transmit at least a portion of light within a wavelength range detectable by the camera.

2. The electrode transport system according to claim 1, further comprising:
a control device,
wherein the control device controls the first plate to adjust the alignment state of the electrode by comparing the alignment information of the electrode confirmed through the camera with a preset alignment information.

3. The electrode transport system according to claim 2, wherein the preset alignment information is information regarding the position of preset reference points corresponding to each of the vertices of the electrode.

4. The electrode transport system according to claim 1, wherein the first transport device includes a second plate including air holes for adsorbing or separating the electrode; and
a driving unit for moving the second plate.

5. The electrode transport system according to claim 4, wherein the first plate includes air holes for adsorbing the electrode placed at the second plate.

6. The electrode transport system according to claim 5, wherein the second plate moves toward to the first plate to adsorb the electrode adsorbed in the air holes of the second plate onto the air holes of the first plate.

7. The electrode transport system according to claim 6, wherein the second plate moves away from the first plate after the electrode is absorbed onto the air holes of the first plate.

8. The electrode transport system according to claim 6, wherein a portion of the second plate facing the support part is formed of the material to transmit at least a portion of light in the wavelength range detectable by the camera.

9. The electrode transport system according to claim 4, wherein the area of the first plate is equal to or greater than the area of the second plate.

10. The electrode transport system according to claim 1, further comprising:
a second transport device for transporting the electrodes to a stacking device for stacking the electrodes.

11. The electrode transport system according to claim 10, wherein the second transport device includes a third plate including air holes arranged to absorb or separate the electrode placed on the first plate and a driving unit for moving the third plate.

12. The electrode transport system according to claim 1, wherein the camera is provided in a plurality and the cameras includes a first camera and a second camera.

13. The electrode transport system according to claim 12, wherein the support part includes a first support part and a second support part, the first support part forms a portion of the shooting region of the first camera on the first plate, and the second support part forms a portion of the shooting region of the second camera on the first plate.

14. The electrode transport system according to claim 13, wherein the first plate further includes a body part between the first support part and the second support part, and the body part is formed of the material to transmit at least a portion of light within a wavelength range detectable by the camera.

15. A control method for an electrode transport system, including a first transport device for transporting the electrode, a first plate onto which the electrode transported from the first transport device is placed, a camera positioned spaced apart from the side of the first plate opposite the side where the electrode is placed and shooting the electrode placed on the first plate; and a support part included within the shooting region of the camera and forming a portion of the first plate, comprising:
a step of placing the electrode from an electrode supply device, where the electrode is placed, onto the first plate through the first transport device;
a step of confirming alignment information of the electrode through the camera; and
a step of adjusting the alignment state of the electrode by comparing the alignment information of the electrode with a preset alignment information,
wherein the support part is formed of a material to transmit at least a portion of light within a wavelength range detectable by the camera.
